(19) United States
(12) Patent Application Publication
(10) Pub. No.: US 2023/0312009 A1
(43) Pub. Date: Oct. 5, 2023

(54) DETACHABLE BACKUP HIGH VOLTAGE BATTERY LOCATED IN FRONT TRUNK

(71) Applicant: Toyota Motor Engineering & Manufacturing North America, Inc., Plano, TX (US)

(72) Inventors: Brian Woods, Brighton, CA (US); Jeremiah Hammer, Ann Arbor, MI (US)

(21) Appl. No.: 17/711,942

(22) Filed: Apr. 1, 2022

(51) Int. Cl. B62D 25/10; B62D 25/08; B60K 11/08; B60R 13/08; B60L 50/60; B60L 1/02; B62D 25/12

(52) U.S. Cl. CPC B62D 25/105; B62D 25/087; B60K 11/08; B60R 13/0838; B60L 50/66; B60L 1/02; B62D 25/12

(57) ABSTRACT

A vehicle includes a power source detachable from the vehicle. The power source is configured to supply power to the vehicle and a remote device. The vehicle includes a front trunk configured to store the power source. The front trunk or at least a portion of the front trunk may be advantageously removable from the vehicle along with the power source. A backup battery may be located in a vehicle's front trunk, where the front trunk and/or the backup battery may be detached from the vehicle itself. The power source may be removable from the front trunk. The power source may then be transported to and placed at a desired or a convenient location to power otherwise difficult to reach remote devices if the power source were to be fixed to the vehicle, such as users who camp off the grid and need power separate from running their vehicle.

### BACKGROUND

### 1. Field

The present disclosure is directed to storage of vehicle power sources, specifically to modular power sources and modular storage areas for power sources removable from the vehicle.

### 2. Description of the Related Art

Fuel-efficient vehicles (e.g., hybrid, plug-in hybrid, electric, fuel cell) continue to gain popularity over the years. Batteries of fuel-efficient vehicles that supply power to their motors (e.g., electric motor, internal combustion engine) to propel the vehicles also supply power to native components of the vehicle (e.g., air conditioner, heater, seat heaters, infotainment unit) as well as external devices (e.g., refrigerator, ventilator, music player, speaker, outdoor light, electric stove, movie projector, smartphone, etc.). Some batteries may even supply power to homes and recreational vehicles (RVs). Particularly, pick-up trucks, sport utility vehicle (SUV), and vehicles towing trailers may use vehicle batteries to supply power to remote devices off the grid while participating in recreational outdoor activities, such as camping, providing emergency services, or working in a construction site by example. Supplementary or back-up batteries may be desirable to maintain or increase the range the vehicle can travel with a single complete battery charge. Due to the versatility of use of vehicle batteries, improving the transportability and storability of vehicle batteries are desirable.

As such, there is a need for modular power sources storable in a front trunk and modular front trunks storing power sources.

### SUMMARY

Described herein is a vehicle. The vehicle includes a power source detachable from the vehicle and configured to supply power to the vehicle and a remote device. The vehicle further includes a front trunk configured to store the power source.

Also described is a vehicle. The vehicle includes a power source detachable from the vehicle and configured to supply power to the vehicle and a remote device. The vehicle further includes a front trunk configured to store the power source. The vehicle further includes a frame configured to support the front trunk, wherein the front truck is detachable from the frame.

Also described herein is a method for operating a vehicle. The method includes providing a power source detachable from the vehicle and configured to supply power to the vehicle and a remote device. The method further includes providing a front trunk configured to store the power source. The method further includes removing the power source from the vehicle.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1A illustrates a front view of a vehicle having a detachable power source located in a front trunk according to an aspect of the present disclosure;

FIG. 1B illustrates a front view of the vehicle of FIG. 1A according to an aspect of the present disclosure;

FIG. 1C illustrates a front view of the vehicle of FIG. 1A according to an aspect of the present disclosure;

FIG. 1D illustrates a front view of the vehicle of FIG. 1A according to an aspect of the present disclosure;

FIG. 2A illustrates a front view of the vehicle of FIG. 1A with the front trunk removed according to an aspect of the present disclosure;

FIG. 2B illustrates a top view of the vehicle of FIG. 2A according to an aspect of the present disclosure;

FIG. 3A illustrates a front view of the vehicle of FIG. 1A having a divider between a cab and the front trunk according to an aspect of the present disclosure;

FIG. 3B illustrates a front view of the vehicle of FIG. 1A having a divider between a cab and the front trunk according to an aspect of the present disclosure;

FIG. 3C illustrates a perspective view of the vehicle of FIG. 3A according to an aspect of the present disclosure;

FIG. 3D illustrates a perspective view of the vehicle of FIG. 3B according to an aspect of the present disclosure;

FIG. 4A illustrates a side view of the vehicle of FIG. 1A using the power source from the front trunk according to an aspect of the present disclosure;

FIG. 4B illustrates a top view of the vehicle of FIG. 1A using an alternative front trunk according to an aspect of the present disclosure;

FIG. 4C illustrates a side view of the vehicle of FIG. 3A according to an aspect of the present disclosure;

FIG. 4D illustrates a top view of the vehicle of FIG. 1A using an alternative front trunk according to an aspect of the present disclosure; and

FIG. 4E illustrates a side view of the vehicle of FIG. 1A using the power source from the front trunk coupled to an alternative external accessory according to an aspect of the present disclosure.

### DETAILED DESCRIPTION

The vehicles, methods and systems described herein permit or allow for a modular power source storage. A vehicle may include a power source detachable from the vehicle. The power source may be a battery or a fuel cell. The power source may supply power to the vehicle (e.g., an electric motor, infotainment system, air conditioning, etc.) and a remote device (e.g., an electronic device, camping equipment, a home, a speaker, a generator, a heater, etc.). The vehicle may further include a front trunk that stores the power source. The power source may be integrated with a portion or portions of the front trunk (e.g., floor, enclosure, etc.).

The front trunk or at least a portion of the front trunk may be advantageously removable from the vehicle along with the power source. For instance, a backup battery located in a vehicle's front trunk may be provided, where the front trunk and/or the backup battery may be detached from the vehicle itself. Alternatively, or additionally, the power source may be advantageously removable from the front trunk. The power source may then be transported to and placed at a desired or a convenient location to power otherwise difficult to reach remote devices if the power source were to be fixed to the vehicle (e.g., users who camp off the grid and need power separate from running their vehicle).

Further, the vehicle may be compatible with various accessories that can be substituted for or adjacent to the power source and/or the front trunk. For instance, once the front trunk and the battery and/or the battery assembly is detached, the vehicle's passenger space and/or storage space remains exposed. As such, the front portion of the vehicle can be replaced with other modular packages, as discussed herein. The term “driver” or “user” may be interchanged with “passenger” when referring to autonomous or semi-autonomous vehicles. The couplings, decouplings, attachments, detachments, and/or the like discussed herein may be performed manually by hand and/or automatically (e.g., springs, motors, etc.). Following a reverse order of operations of couplings or attachments discussed herein may describe decouplings or detachments and vice versa.

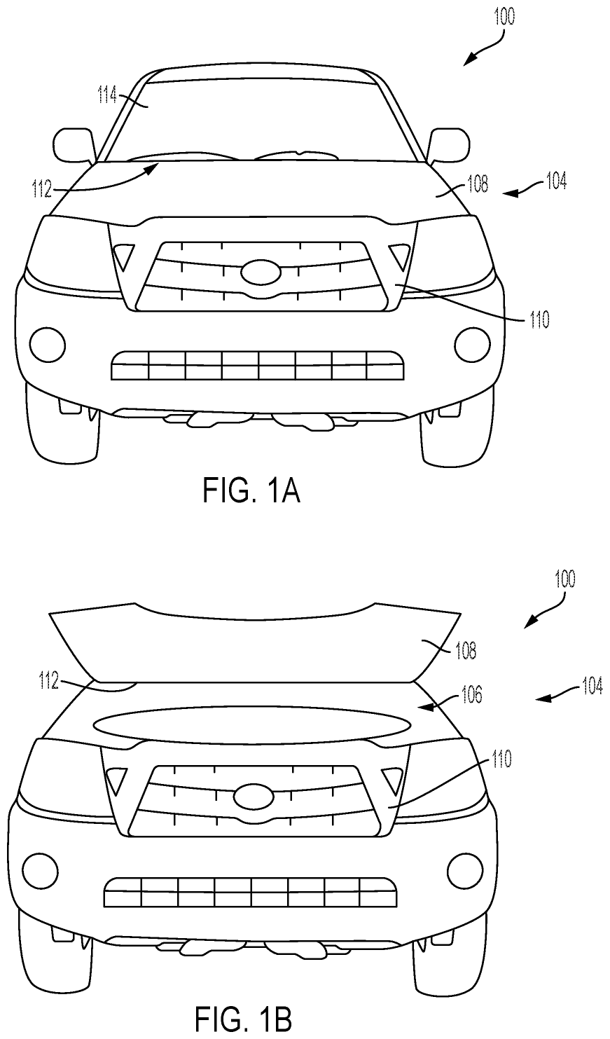

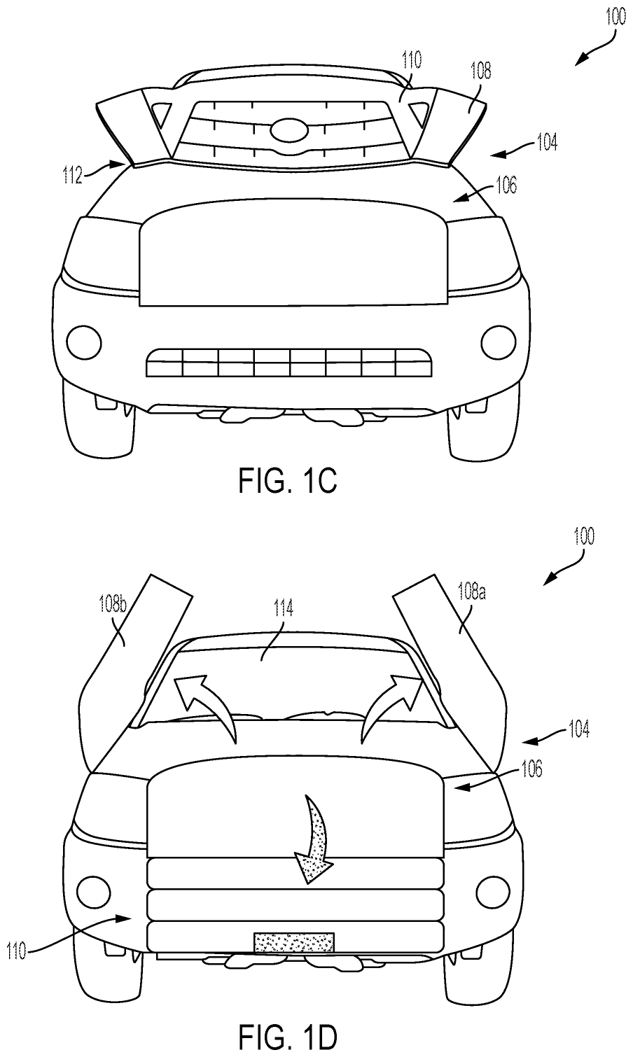

FIGS. 1A-1D illustrate a front view of a vehicle 100 having a power source 102 (not shown) installed in the front trunk 104. The vehicle 100 may be a vessel that is configured to transport one or more persons. The vehicle 100 may be a truck, or more specifically, a pick-up truck. The vehicle 100 may be an electric vehicle where the power source 102 is a battery (or multiple batteries). The vehicle 100 may be fully electric and solely rely on an electric motor to propel the vehicle 100 forward. In another example, the vehicle 100 may be a partial electric vehicle, such as a hybrid vehicle or a plug-in hybrid vehicle, where an internal combustion engine and an electric motor in combination propels the vehicle 100 forward. In such an example, the power source 102 may be partially one or more batteries. In yet another example, the vehicle 100 may be a hydrogen fuel-cell vehicle that has a fuel cell and a battery as the power source 102 for an electric motor to draw electricity from.

In FIGS. 1A-1D, the power source 102 is a battery by example. The battery may be one or more batteries connected to each other and to the primary battery that powers the electric motor of the vehicle 100. The battery may also provide power to other electrical components associated with the vehicle 100 or external to the vehicle 100. For example, the electrical components may be an air conditioner, a seat heater, a heater, an infotainment unit, a telephone, a refrigerator, a ventilator, an electronic device being charged, lights, a sound system, a winch, a television display, a gaming console, and/or the like.

The battery may be any kind of battery, for example, a lithium-ion battery. The battery may require charging at a charging station as needed based on battery charge consumption similar to fueling a vehicle at a gas station. The charging station may be a designated charging station that resembles a gas station or may be located at one's home garage, a public or private parking garage, a parking lot, and the like. The battery may have a common AC input for charging from any home or business. The battery may have direct access input for solar, fuel cell, or other external power generating sources.

The front trunk 104 may define a recess or cavity 106 that extends below a vehicle hood 108 and behind a vehicle grille 110. The power source 102 or the battery may be integrated with the front trunk 104 of the vehicle 100. The power source 102 may be fully or partially enclosed or encased by the front trunk 104. The front trunk 104 may be made from a material or materials that protect the power source 102. For example, the front trunk 104 may be coated with a liner material (e.g., a vinyl polymer, rubber, carpet, composite, or a combination of the aforementioned) that provides additional protection and grip. The front truck may include weather-stripping to seal against mating components (e.g., hood) and prevent water, weather or contaminant ingress. Additionally, the front trunk 104 may include impact and/or compression resistant material to protect the power source 102 from damage (e.g., harsh impact if the vehicle 100 is in a collision). When in the front trunk 104, the power source 102 is secured and attached to the vehicle 100 and/or the front trunk 104 to prevent the power source 102 from moving while the vehicle 100 is travelling.

As shown in FIG. 1B, the front trunk 104 may be accessed by lifting the vehicle hood 108 away from the compartment enclosure. The vehicle hood 108 may be rotatably coupled to the vehicle 100 (e.g., hinged) at a first side 112 (e.g., the front bulk-head). The first side 112 may be located adjacent to a front windshield 114. For instance, the vehicle hood 108 may hinge up and down from coupling points along the first side 112 to access under the vehicle hood 108 and into the cavity 106 of the front trunk 104. In various embodiments, the vehicle 100 may include pneumatic struts and/or remote activated lift struts to provide an easy open/access feature for the user.

In some embodiments, as shown in FIG. 1C, the front trunk may be accessed by lifting the vehicle hood 108 and/or the vehicle grille 110. For instance, the vehicle hood 108 and the vehicle grille 110 may be coupled such that when the vehicle hood 108 is rotated along the coupling points of the first side 112, the vehicle grille 110 is lifted away from the cavity 106 of the front trunk 104 as well.

Alternatively, as shown in FIG. 1D, the vehicle 100 may include a first hood section 108a and a second hood section 108b. In such a configuration, the front trunk 104 may be accessed by lifting the first hood section 108a and the second hood section 108b away from the vehicle grille 110 in opposite directions. The first hood section 108a may be rotatably coupled to the vehicle 100 (e.g., hinged) at a second side 116. The second hood section 108b may be rotatably coupled to the vehicle 100 (e.g., hinged) at a third side 118. The first and second sides 116, 118 may be oriented perpendicular to the first side 112 and opposite each other. For instance, the first and second hood sections 108a, 108b may hinge up (e.g., away from the vehicle grille 110) and down from coupling points along the first and second sides 116, 118, respectively, to access under the cavity 106 of the front trunk 104. In various embodiments, the vehicle grille 110 may include two segments each coupled to the first and second hood sections 108a, 108b, wherein the two segments (not shown) of the vehicle grille 110 may lift with the first and second hood sections 108a, 108b. Additionally, the vehicle grille 110 may be configured to fold down, exposing the cavity 106. The vehicle grille 110, configured to fold down, may be configured into a step to boost the user and create a more easily accessible front trunk 104. The fold down grille 110 may additionally be configured with the embodiment described with reference to FIG. 1B.

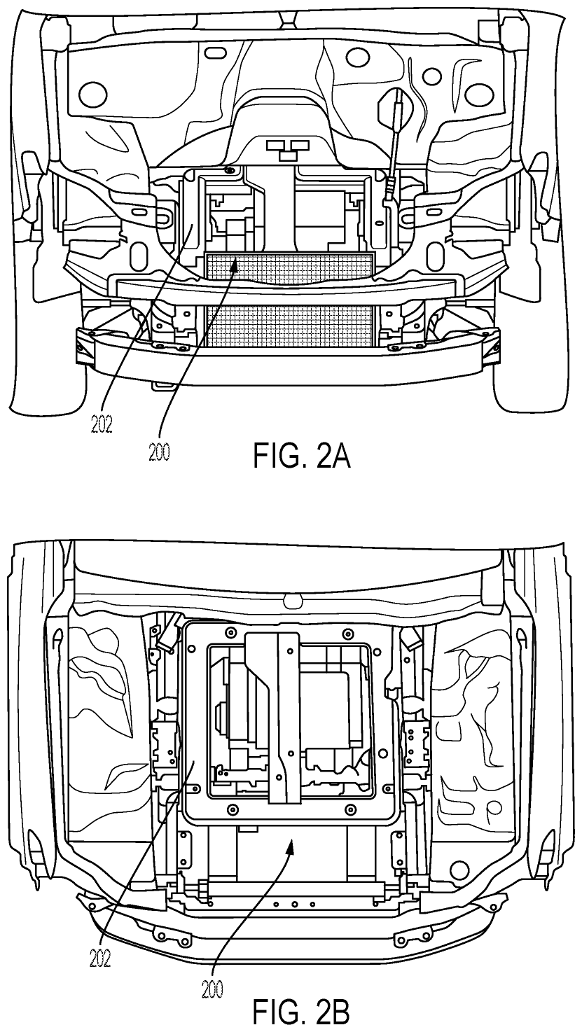

Referring now to FIGS. 2A-2B, the front trunk 104 may be supported by a frame 200.

In some embodiments, the front trunk 104 may have mounts attached to one or more frame body structure components 202 of the vehicle that support a bottom surface of the front trunk 104. The front trunk 104 may be fastened to the frame 200 with conventional fasteners (e.g., tracks, clips, hooks, anchors, screws, etc.) to prevent the front trunk 104 from detaching from the frame 200 while the front trunk 104 is installed. For instance, the front trunk 104 may include clips on an underside of the front trunk 104 (e.g., the opposite surface of the liner, opposite the cavity 106) that are configured to couple to ridges disposed on the one or more frame body structure components 202. The power source 102 may similarly be fastened to the front trunk 104 with conventional fasteners (e.g., tracks, clips, hooks, anchors, screws, etc.) to prevent the power source 102 from detaching from the front trunk 104 while the power source 102 is installed and from disconnecting from the electric motor and the electric circuit of the vehicle 100, especially when the vehicle 100 is in motion. For instance, the fasteners may be disposed on a rear surface of the front trunk 104 (e.g., an interior surface of the front trunk 104 furthest from the vehicle grille 110) and correspond with a mating mechanism located on the power source 102. The fasteners may be located on the rear surface to ensure proper attachment to the vehicle 100. The fasteners may be clamps or hooks that are simple for the user to detach the power source 102 from the front trunk 104 and/or the frame 200. For instance, the fastener on the rear surface of the front trunk 104 may be a U-shaped anchor configured to receive a hook disposed on the adjacent surface of the power source 102.

While within the recess 106, the power source 102 may be electrically coupled to the primary battery of the vehicle 100 in order to extend the driving range. In various embodiments, the power source 102 may be electrically coupled to the auxiliary devices, which are electrically coupled to an electrical circuit of the vehicle 100. The electrical connection may be configured to run through a surface of the front trunk 104. For instance, the front trunk 104 may have a through hole to allow access to the main power source 102 while retaining the aesthetic advantages of a front trunk (e.g., the frame, motor, etc. are not exposed).

The power source 102 may be lifted up from and out of the recess 106 when the user desires to use the power source 102 as a backup battery. For instance, in addition to using the power source 102 as a range extender for the vehicle 100, the power source 102 may be removed to act as a generator/power station to provide energy for a home, a business, and/or a remote off-grid location. The power source 102 is configured to be manually manipulated/liftable by an average user. The power source 102 may be stackable and the vehicle 100 may include a plurality of power sources 102. The user then has the option of removing one or more power sources 102 from the front trunk 104. The power source 102 may have one or more grips to grab during attachment and detachment. The grips may be coated with a conventional gripping material (e.g., synthetic leather, silicone, nitrile, etc.) to reduce or prevent slipping. The grips may be located on opposing sides of each other. The grips may be distanced from each other by a length that is approximately equal to or less than an average width of an adult to allow for one individual to detach and carry the power source 102 from the vehicle 100. Alternatively, the vehicle may include an electronic lifting mechanism to aid in the removal of the power source 102 and/or the front trunk 104.

Once detached from the vehicle 100, the power source 102 may be transported to a location away from the vehicle 100 and positioned as desired to supply power to remote devices. The power source 102 may be held from the grips 114 during transport. In some embodiments, the power source 102 may have one or more wheels and a handle, which may be telescoping, to roll the power source 102 on a ground surface like a rolling backpack or a cooler.

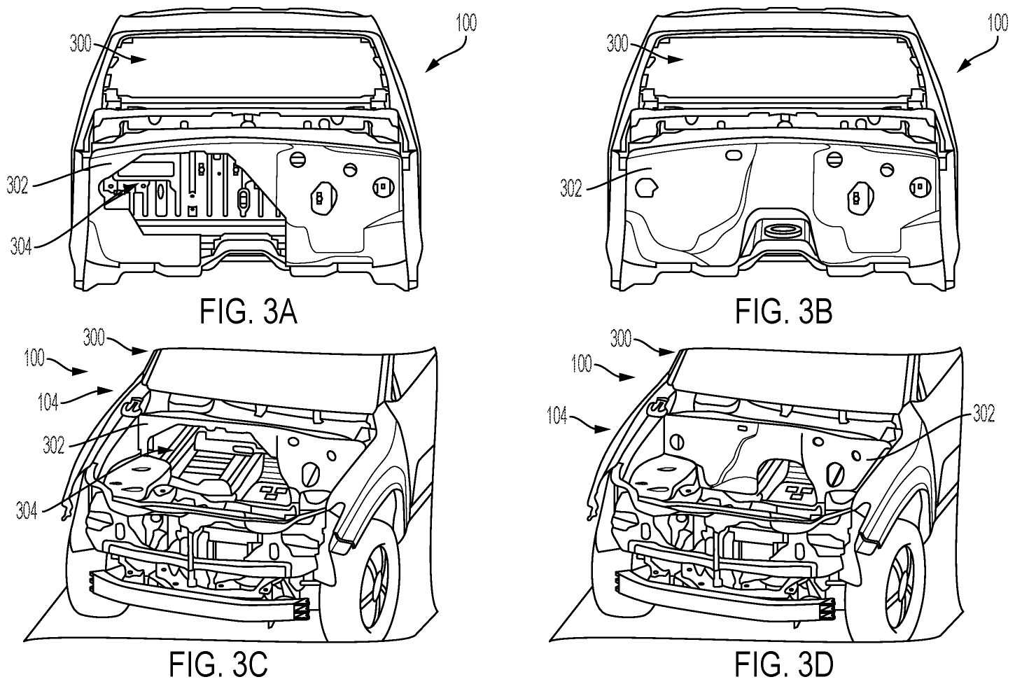

Referring now to FIGS. 3A-3D, the vehicle 100 may have a cabin 300. The cabin 300 may hold at least one person, which may be a driver and/or a passenger. The cabin 300 may be coupled to a divider 302 of the vehicle 100. The divider 302 is a barrier between the cabin 300 and the motor, the battery, and additional functional equipment of the vehicle 100. Typically, as shown in FIGS. 3B and 3D, the divider 302 is substantially solid, with few small through holes allowing access between the cabin 300 and the components stored in the front of the vehicle 100. In various embodiments, as shown in FIGS. 3A and 3C, the divider 300 may be modified to allow a seat and/or a passenger to pass through and utilize the front trunk space. For instance, when the power source 102 is removed from the front trunk 104, more space is available in the cavity 106. It is advantageous to allow the passenger to stretch out their legs in front of them (see FIG. 5C). As such, an opening 304 is provided in the divider 302 to allow more access between the cabin 300 and the front trunk 104.

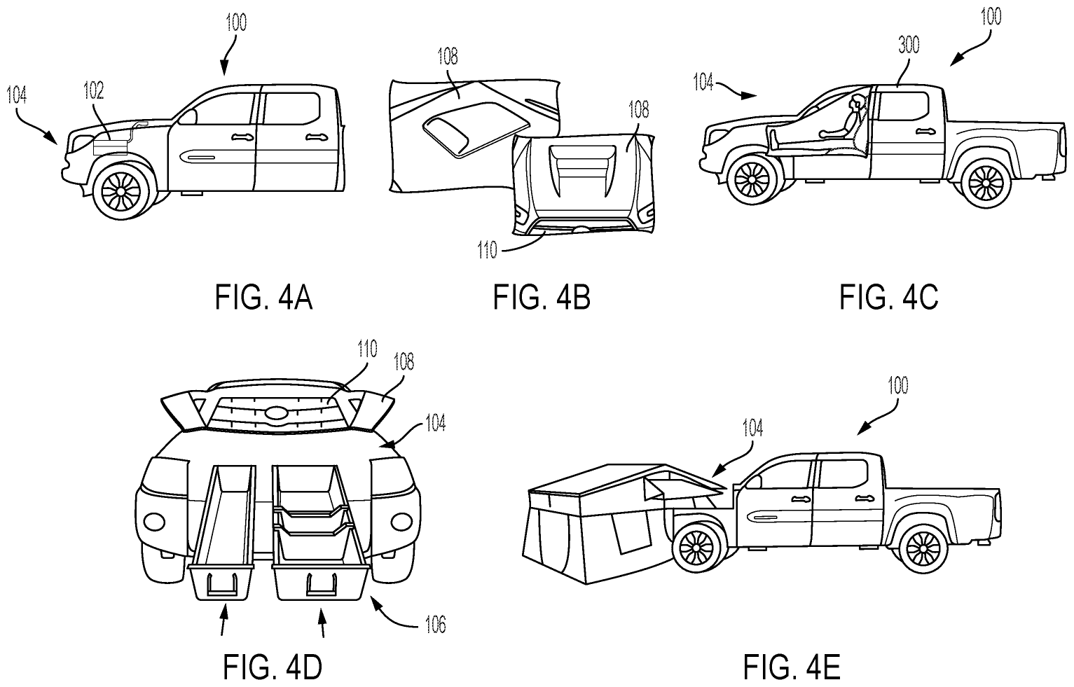

Referring now to FIGS. 4A-4E, additional advantages of the power source 102 removable from the front trunk 104 are illustrated. As shown in FIG. 4A, the power source 102 may be installed in the front trunk 104 and connected to the vehicle 100 to act as a range extender battery, a power station, and/or a generator. Further, the front trunk 104 may be replaced with a front trunk the user prefers based on a custom hood scoop insert, a custom radiator grille insert, and “front-gating” accessories (e.g., ice chest or cooler, food preparation and/or warming devices, stereo equipment, etc.) (see FIG. 4B). For example, the front fascia, grille, bumper, or any other exterior component coupled to the front trunk are replaceable with other modular front trunk packages having varying features/functions. The vehicle front trunk can be replaced with a design that improves the vehicle's styling, and function (e.g., appearance, aerodynamics, lighting, performance features, etc.) as well as using the removable module as an independent storage/cooler/generator for use away from the vehicle, for example, while camping, construction sites, tail-gating, etc. With the power source 102 removed from the front trunk 104, the user may also utilize the extra space and install a stereo/speaker system or use the space for a supplemental storage accessory including drawers that can slide in and out of the front trunk 104 (see FIG. 4D). In various embodiments with the opening 304 in the divider 300 of FIG. 3, a front trunk storage unit may be available that extends into the cabin as well. Lastly, as shown in FIG. 4E and discussed herein, the power source 102 may be used in remote locations, such as during camping, allowing users to directly plug into the power source 102 located in the front trunk 104 or removed. The front trunk 104 may be used to store the tent and/or adapt to function with the tent as additional storage. Although these figures are intended to provide examples of the detachable backup high voltage battery located in the front trunk 104, this list is in no way meant to be exhaustive.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A vehicle comprising:
a power source detachable from the vehicle and configured to supply power to the vehicle and a remote device; and
a front trunk configured to store the power source.

2. The vehicle of claim 1, wherein the front trunk is configured to be removed from the vehicle.

3. The vehicle of claim 1, further comprising a vehicle hood and a vehicle grille wherein the front trunk defines a cavity extending below the vehicle hood and behind the vehicle grille.

4. The vehicle of claim 3, wherein the vehicle hood and the vehicle grille are coupled together such that the vehicle good and the vehicle grill are configured to move together.

5. The vehicle of claim 3, further comprising a front trunk accessory configured to correspond with the cavity and replace the front trunk once removed.

6. The vehicle of claim 1, further comprising a first hood section, a second hood section, and a vehicle grille wherein the front trunk defines a cavity extending below the first and second hood sections and behind the vehicle grille.

7. The vehicle of claim 6, wherein the first hood section and the second hood section are configured to move away from the vehicle grille in opposite directions.

8. The vehicle of claim 1, further comprising a frame configured to support the front trunk, wherein the frame comprises at least one sidewall.

9. The vehicle of claim 8, wherein the frame is configured to be fastened to the front trunk via a fastener.

10. The vehicle of claim 1, further comprising:
a cabin configured to hold a person; and
a divider separating the cabin and the front trunk.

11. The vehicle of claim 10, wherein the divider defines an opening configured to allow the person to extend through the opening from the cabin to the front trunk.

12. A vehicle comprising:
a power source detachable from the vehicle and configured to supply power to the vehicle and a remote device;
a front trunk configured to store the power source; and
a frame configured to support the front trunk, wherein the front truck is detachable from the frame.

13. The vehicle of claim 12, wherein the frame comprises two or more body structure components, the two or more body structure components configured to be fastened to the front trunk via a fastener.

14. The vehicle of claim 12, further comprising:
a cabin configured to hold a person; and
a divider separating the cabin and the front trunk.

15. The vehicle of claim 14, wherein the divider defines an opening configured to allow the person to extend through the opening from the cabin to the front trunk.

16. The vehicle of claim 12, wherein the power source is a plurality of modular batteries configured to be stacked on top of or next to each other.

17. The vehicle of claim 12, further comprising a front trunk accessory configured to correspond with the cavity and replace the front trunk once removed.

18. A method for operating a vehicle, the method comprising:
providing a power source detachable from the vehicle and configured to supply power to the vehicle and a remote device;
providing a front trunk configured to store the power source; and
removing the power source from the vehicle.

19. The method of claim 18, further comprising supplying power from the removed power source to a remote device.

20. The method of claim 18, further comprising:
removing the front trunk from a frame configured to support the front trunk, wherein the frame comprises two or more body structure components configured to be fastened to the front trunk via a fastener; and
replacing the remove front trunk with a front trunk accessory.
